(19) United States
(12) Patent Application Publication
(10) Pub. No.: US 2012/0113113 A1
(43) Pub. Date: May 10, 2012

(54) METHOD OF PROCESSING DATA FOR 3D IMAGES AND AUDIO/VIDEO SYSTEM

(76) Inventor: Yeon Hyuk Hong, Seoul (KR)

(21) Appl. No.: 13/381,520

(22) PCT Filed: Feb. 3, 2010
(86) PCT No.: PCT/KR2010/000674

§ 371 Date: Dec. 29, 2011

Related U.S. Application Data
(60) Provisional application No. 61/221,562, filed on Jun. 30, 2009.

(51) Int. Cl. G06T 15/00

(52) U.S. Cl. 345/419

(57) ABSTRACT

A method of processing 3-dimensional (3D) images and an audio/video (A/V) system are disclosed herein. The A/V system includes a source device providing one of a 2D image signal and a 3D image signal through a digital interface, and a sink device processing and displaying one of the 2D image signal and the 3D image signal provided through the digital interface. Herein, the sink device transmits identification information indicating whether or not the sink device supports 3D images from to the source device. And, when the sink device is verified to be 3D-supportable based upon the identification information, the source device transmits the 3D image signal to the sink device.

### TECHNICAL FIELD

The present invention relates to a method and device for processing an image signal and, more particularly, to a method of processing 3-dimensional (3D) images and an audio/video system.

### BACKGROUND ART

Generally, a 3-dimensional (3D) image (or stereoscopic image) is based upon the principle of stereoscopic vision of both human eyes. A parallax between both eyes, in other words, a binocular parallax caused by the two eyes of an individual being spaced apart at a distance of approximately 65 millimeters (mm) is viewed as the main factor that enables the individual to view objects 3-dimensionally. When each of the left eye and the right eye respectively views a 2-dimensional (or flat) image, the brain combines the pair of differently viewed images, thereby realizing the depth and actual form of the original 3D image.

Such 3D image display may be broadly divided into a stereoscopic method, a volumetric method, and a holographic method.

### DISCLOSURE OF INVENTION

### Technical Problem

Accordingly, the present invention is directed to a method of processing 3-dimensional (3D) images and an audio/video system that substantially obviate one or more problems due to limitations and disadvantages of the related art.

An object of the present invention is to provide a method of processing 3-dimensional (3D) images and an audio/video system that can provide identification information to a source device, wherein the provided identification information enables the source device to recognize 3D image support provided by a sink device, when the sink device supports 3D images.

Another object of the present invention is to provide a method of processing 3-dimensional (3D) images and an audio/video system that can deliver (or transmit) 3D images from the source device to the sink device based upon the provided identification information.

A further object of the present invention is to provide a method of processing 3-dimensional (3D) images and an audio/video system that can provide 3D images with an optimal resolution, when a 3D image is provided from the source device to the sink device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Solution to Problem

To achieve these objects and other advantages and in accordance with the purpose of the invention, as embodied and broadly described herein, in a method of processing 3-dimensional (3D) images of an audio/video system, wherein the audio/video (A/V) system includes a sink device and a source device connected through a digital interface, the method of processing 3D images of the audio/video system includes transmitting identification information indicating whether or not the sink device supports 3D images from the sink device to the source device, and, when the sink device is verified to be 3D-supportable based upon the identification information, transmitting a 3D image signal from the source device to the sink device.

In another aspect of the present invention, the A/V system includes a source device providing one of a 2D image signal and a 3D image signal through a digital interface, and a sink device processing and displaying one of the 2D image signal and the 3D image signal provided through the digital interface. Herein, the sink device transmits identification information indicating whether or not the sink device supports 3D images to the source device. And, when the sink device is verified to be 3D-supportable based upon the identification information, the source device transmits the 3D image signal to the sink device.

The sink device may set up resolution information including at least one resolution supportable for 3D images in a video block of the EDID, thereby transmitting the resolution information to the source device.

Among the resolutions included in the resolution information transmitted from the sink device, the source device may transmit the 3D image signal at a resolution of a highest picture quality.

If the resolution set up in the source device is lower than a resolution of a highest picture quality, the resolution being supportable for 3D images, the sink device may display a guidance message enabling a user to recognize the resolution of the highest picture quality supportable by the sink device.

When resolution settings of the source device are changed by the user to the resolution of the highest picture quality, the source device may transmit the 3D image signal at the changed resolution.

It is to be understood that both the foregoing general description and the following detailed description of the present invention are exemplary and explanatory and are intended to provide further explanation of the invention as claimed.

### Advantageous Effects of Invention

The method of processing 3-dimensional (3D) images and the audio/video system according to the present invention have the following advantages. If the sink device according to the present invention supports 3D images, the sink device provides identification information indicating that the corresponding sink device is 3D-supportable to the source device. Thereafter, only when the identification information is provided, the source device transmits the 3D image to the sink device. Thus, sink devices that does not support 3D images are incapable of receiving 3D images, thereby preventing the problems that occurred when 3D-non-supportable sink devices received 3D images.

If the sink device supports 3D images, the source device receives resolution information supported for the 3D image from the sink device. Then, among the received resolution information, the 3D image is transmitted to the sink device at an optimal resolution. If the selected resolution does not correspond to the optimal resolution, the system outputs a guidance message enabling the user to set up the optimal resolution. Thus, the user may view the 3D image at the optimal resolution.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block diagram showing a source device being connected to a sink device through a digital interface according to an embodiment of the present invention;

FIG. 2 illustrates a detailed block diagram of a source device and a sink device according to an embodiment the present invention, when the sink device corresponds to a digital television (TV) receiver;

FIG. 3 illustrates of setting-up identification information to recognize that a respective sink device supports 3D images;

FIG. 4 to FIG. 6 respectively illustrate examples of setting-up (or determining) resolutions supportable by the sink device according to the present invention; and

FIG. 7 illustrates a flow chart showing the process steps of a method of processing data for 3D images in the source device and the sink device according to an embodiment of the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

Herein, 3D images may include stereo (or stereoscopic) images, which take into consideration two different perspectives (or viewpoints), and multi-view images, which take into consideration three different perspectives. A stereo image refers to a pair of left-view (or left-eye) and right-view (or right-eye) images acquired by photographing the same subject with a left-side camera and a right-side camera, wherein both cameras are spaced apart from one another at a predetermined distance. Furthermore, a multi-view image refers to a set of at least 3 images acquired by photographing the same subject with at least 3 different cameras either spaced apart from one another at predetermined distances or placed at different angles.

Additionally, the display method for showing (or displaying) 3D images may broadly include a method of wearing special glasses, and a method of not wearing any glasses. The method of wearing special glasses is then divided intro a passive method and an active method. The passive method corresponds to a method of showing the 3D image by differentiating the left image and the right image using a polarizing filter. More specifically, the passive method corresponds to a method of wearing a pair of glasses with one red lens and one blue lens fitted to each eye, respectively. The active method corresponds to a method of differentiating the left image and the right image by sequentially covering the left eye and the right eye at a predetermined time interval. More specifically, the active method corresponds to a method of periodically repeating a time-split (or time-divided) and viewing the corresponding image through a pair of glasses equipped with electronic shutters which are synchronized with the time-split cycle period of the image. The active method may also be referred to as a time-split method or a shuttered glass method.

The most well-known methods of not wearing any glasses include a lenticular method and a parallax barrier method. Herein, the lenticular method corresponds to a method of fixing a lenticular lens panel in front of an image panel, wherein the lenticular lens panel is configured of a cylindrical lens array being vertically aligned. The parallax method corresponds to a method of providing a barrier layer having periodic slits above the image panel.

In the present invention, a 3D image may either be directly supplied to the receiving system through a broadcasting station or be supplied to the receiving system from the source device. Herein, any device that can supply (or provide) 3D images, such as personal computers (PCs), camcorders, digital cameras, digital video disc (DVD) devices (e.g., DVD players, DVD recorders, etc.), settop boxes, digital television (TV) receivers, and so on, may be used as the source device. In the description of the present invention, a device that receives and displays 3D images provided from a broadcasting station or a source device will be referred to as a receiving system. Herein, any device having a display function, such as digital TV receivers, monitors, and so on, may be used as the receiving system. The source device may also provide 2D images to the receiving system.

At this point, if the source device provides 2D/3D images to the receiving system through a digital interface, the receiving system may be referred to as a sink device. Also, in the description of the present invention, the source device and the sink device will be collectively referred to as an audio/video (A/V) system, for simplicity.

More specifically, according to an embodiment of the present invention, the source device and the sink device uses a digital interface to transmit and/or receive 3D image signals and control signals. Furthermore, the source device and the sink device may also transmit and/or receive 3D image signals and control signals by using a digital interface.

Herein, digital interfaces may include a digital visual interface (DVI), a high definition multimedia interface (HDMI), and so on. According to an embodiment of the present invention, the HDMI will be used as the digital interface. In this case, the source device and the sink device are connected to an HDMI cable.

However, when transmitting 3D images to the sink device, the source device is unable to know whether the corresponding sink device supports 3D images.

If the sink does not support 3D images, even though the source device provides 3D images to the sink device, the sink device is incapable of properly processing the provided 3D images. Thus, the image may be displayed incorrectly, or the image may not be displayed at all.

In order to resolve the above-described problem, if the sink device supports 3D images, the sink device is designed to provide identification information to the source device, wherein the identification information enables the source device to recognize the 3D image support of the sink device. And, depending upon the identification information, the source device may provide 3D images to the sink device, only when the corresponding sink device supports 3D images.

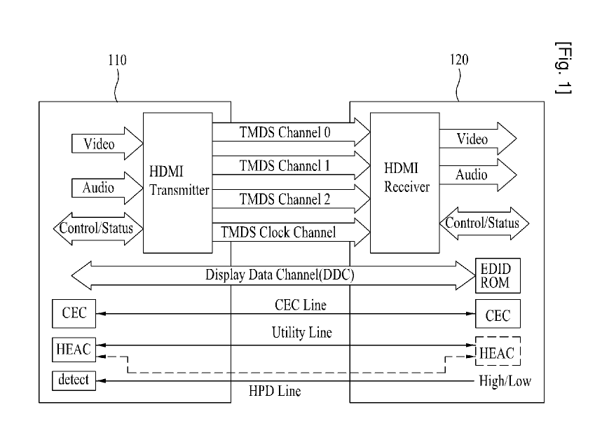

FIG. 1 illustrates a block diagram showing a source device being connected to a sink device through a digital interface according to an embodiment of the present invention. More specifically, FIG. 1 shows an example of one source device being connected to a sink device. However, this is merely exemplary. Therefore, depending upon the number of HDMI ports provided in the sink device, at least one or more source devices may be connected to the sink device.

A source device 110 includes an HDMI transmitter. And, a sink device 120 includes an HDMI receiver and a non-volatile memory. According to the embodiment of the present invention, an electrically erasable programmable read-only memory (EEPROM), which can modify (or change) the data stored in the memory while still being capable of maintaining the stored data even when the power is turned off, is used as the non-volatile memory of the sink device 120. Referring to FIG. 1, the HDMI supports a high-bandwidth digital content protection (HDCP) standard for preventing illegal copying (or duplication) of the content, an extended display identification data (EDID) standard, a display data channel (DDC) standard used for reading and analyzing the EDID, a consumer electronics control (CEC), and an HDMI Ethernet and audio return channel.

The EDID stored in the EEPROM of the sink device 120 is delivered to the source device 110 through the DDC. For example, depending upon the I2C telecommunication standard, the EDID stored in the EEPROM is transmitted to the source device 110. The EEPROM stores a physical address and a logical address of the source device as the EDID. The EEPROM also stores display property information (e.g., manufacturing company, standard, supportable resolution, color format, etc.) as the EDID. The EDID is created (or generated) by a respective manufacturing company during the manufacturing process of the sink device, thereby being stored in the EEPROM. By verifying the EDID transmitted from the sink device 120, the source device 110 may refer to diverse information, such as manufacturing company ID, product ID, serial number, and so on.

Additionally, the HDMI uses a transition minimized differential signaling interface (TMDS). More specifically, in the HDMI transmitter of the source device 110, 8 bits of digital audio/video (A/V) data are converted to a 10-bit transition-minimized DC value and serialized, thereby being transmitted to the HDMI receiver of the sink device 120. The HDMI receiver of the sink device 120 then de-serialized the received A/V data, so as to convert the received data to 8 bits. Accordingly, an HDMI cable requires 3 TMDS channels in order to transmit the digital A/V data. Furthermore, the 3 TMDS channels and a TMDS clock channel may be combined to configure a TMDS link.

More specifically, the HDMI transmitter of the source device 110 performs synchronization of A/V data between the source device 110 and the sink device 120 through the TMDS clock channel. Also, the HDMI transmitter of the source device 110 may transmit a 2D-specific video signal or transmit a 3D-specific video signal to the HDMI receiver of the sink device 120 through the 3 TMDS channels. Additionally, the HDMI transmitter of the source device 110 transmits infoframes of supplemental data to the HDMI receiver of the sink device 120 through the 3 TMDS channels.

Moreover, in the HDMI, the usage of the CEC is optional. The CEC protocol provides high-level control functions between all of the various audiovisual products in a user's environment. For example, the CEC is used for automatic setup tasks or tasks associated with a universal (or integrated) remote controller. Also, the HDMI supports Ethernet and an audio-return channel. More specifically, the HEAC provides Ethernet-compatible data networking between connected devices and an audio-return channel in a direction opposite from the TMDS.

Furthermore, the source device 110 may provide 2D images or 3D images to the sink device 120. For example, when it is assumed that a settop box corresponds to the source device 110, the settop box may receive a 2D image or a 3D image from a broadcasting station and may provide the received image to the sink device 120. If the source device 110 corresponds to a DVD player, the DVD player may read a 2D or 3D image from a respective disc and may provide the image to the sink device 120.

If the source device 110 provides a 3D image to the sink device 120, the source device 110 may also provide a structure of the 3D image, so that the sink device 120 can process and display the 3D image. The structure of the 3D image includes a transmission format of the 3D image. The transmission format may include a frame-packing format, a field alternative format, a line alternative format, a side-by-side format, an L+depth format, an L+depth+graphics+graphics+depth format and so on. For example, the side-by-side format corresponds to a case where a left image and a right image are ½ sub-sampled in a horizontal direction. Herein, the sampled left image is positioned on the left side, and the sampled right image is positioned on the right side, thereby creating a single stereo image. The top/bottom format corresponds to a case where a left image and a right image are ½ sub-sampled in a vertical direction. Herein, the sampled left image is positioned on the upper (or top) side, and the sampled right image is positioned on the lower (or bottom) side, thereby creating a single stereo image. The L+depth format corresponds to a case where one of a left image and a right image is transmitted along with depth information for creating another image.

However, if the sink device 120 does not support 3D images, even though the source device 110 provides 3D images and the structure of the 3D images, the sink device 120 is incapable of properly processing the 3D image. In this case, an error image may be displayed, or the image may not be displayed at all. According to an embodiment of the present invention, in order to prevent such a problem from occurring, if the sink device 120 supports 3D images, the sink device 120 provides identification information to the source device 110, so that the source device 110 can recognize the sink device 120 as being capable of supporting 3D images.

According to the embodiment of the present invention, the sink device 120 determines (or sets up) identification information enabling 3D-support recognition in the EDID stored in the EEPROM. Subsequently, the sink device 120 transmits the EDID to the source device 110 through the DDC. The source device 110 then analyses the EDID received through the DDC. Thereafter, when it is verified that the sink device 120 supports 3D images, the source device 110 provides the 3D image to the sink device 120. Additionally, according to the embodiment of the present invention, the source device 110 also transmits a transmission format of the 3D image to the sink device 120. Meanwhile, if it is verified that the sink device 120 that has transmitted the EDID does not support 3D images, the source device 110 provides a 2D image to the sink device 120.

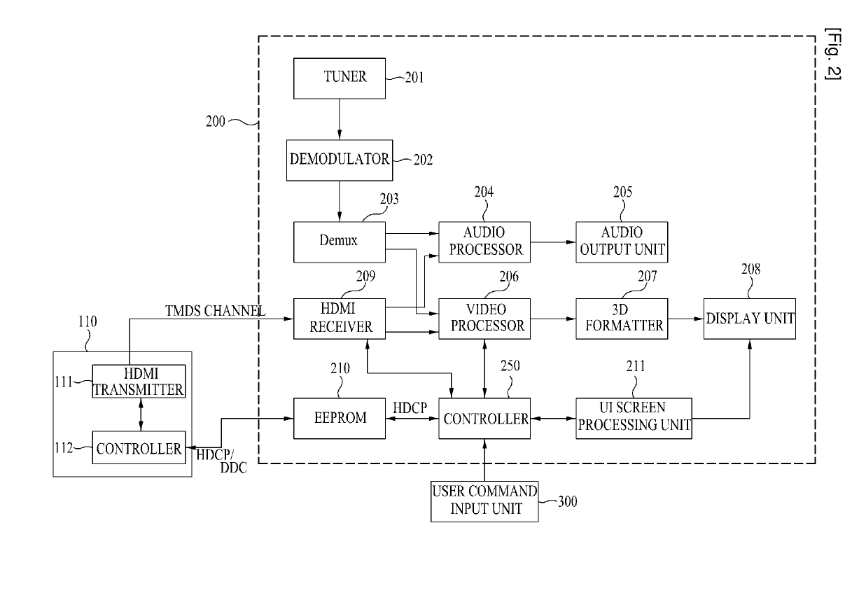

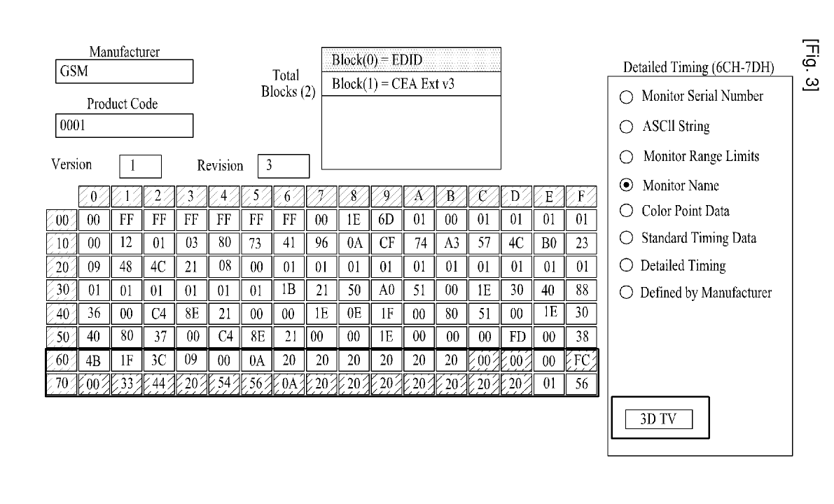

FIG. 2 illustrates a detailed block diagram of a source device and a sink device according to an embodiment the present invention, when the sink device corresponds to a digital television (TV) receiver.

In the AN system of FIG. 2, the source device 110 is identical to the source device 110 shown in FIG. 1. Herein, the source device 110 includes an HDMI transmitter 111 and a controller 112. Also, the sink device 200 includes a tuner 201, a demodulator 202, a demultiplexer 203, an audio processor 204, an audio output unit 205, a video processor 206, a 3D formatter 207, a display unit 208, an HDMI receiver 209, an EEPROM 210, a user interface (UI) screen processing unit 211, and a controller 250. According to the embodiment of the present invention, elements (or parts) that are not described in FIG. 2 correspond to elements of FIG. 1 directly applied to FIG. 2 without modification.

The display unit 208 may correspond to a display panel that can display general 2D images, a display panel that can display 3D images requiring special glasses, or a display panel that can display 3D images without requiring any special glasses.

More specifically, the sink device 200 according to the embodiment of the present invention may receive a broadcast signal from a broadcasting station and may also receive a video signal from the source device through a digital interface (i.e., HDMI). The broadcast signal is tuned by the tuner 201 and inputted to the demodulator 202. The demodulator 202 performs demodulation on the broadcast signal being outputted from the tuner 201 as an inverse process of the modulation process performed by the transmitting system, such as the broadcasting station. For example, if the broadcasting station has performed vestigial side-band (VSB) modulation on a broadcast signal, the demodulator 202 performs VSB demodulation on the inputted broadcast signal, thereby outputting the demodulated signal to the demultiplexer 203 in a transport stream (TS) packet format.

The demultiplexer 203 receives the TS packet so as to perform demultiplexing. The TS packet is configured of a header and a payload. Herein, the header includes a PID, and the payload includes any one of a video stream, an audio stream, and a data stream. The demultiplexer 203 uses the PID of the inputted TS packet so as to determine whether the stream contained in the corresponding TS packet corresponds to a video stream, an audio stream, or a data stream. Thereafter, the demultiplexer 203 outputs the determined stream to the respective decoder. More specifically, if the determined stream corresponds to an audio stream, the demultiplexer 203 outputs the corresponding stream to the audio processor 204. And, if the determined stream corresponds to a video stream, the demultiplexer 203 outputs the corresponding stream to the video processor 206. Finally, the determined stream corresponds to a data stream, the demultiplexer 203 outputs the corresponding stream to a data processor (not shown). Herein, the data stream includes system information. However, since the data stream does not correspond to the characteristics of the present invention, detailed description of the same will be omitted herein for simplicity.

If an audio stream is compression-encoded, the audio processor 204 decodes the audio stream using a predetermined audio decoding algorithm, so as to recover the audio stream to its initial state prior to being compression-encoded, thereby outputting the processed audio stream to the audio output unit 205. The audio output unit 205 converts the decoded audio signal to an analog signal, thereby outputting the analog audio signal to a speaker. Alternatively, if a video stream is compression-encoded, the video processor 206 decodes the video stream using a predetermined video decoding algorithm, so as to recover the video stream to its initial state prior to being compression-encoded. The video decoding algorithm includes an MPEG-2 video decoding algorithm, an MPEG-4 video decoding algorithm, an H.264 decoding algorithm, an SVC decoding algorithm, a VC-1 decoding algorithm, and so on.

It is assumed that the video stream decoded by the video processor 206 is a video stream for 2D images. In this case, the decoded video stream bypasses the 3D formatter 207, so as to be outputted to the display unit 208. More specifically, in the present invention, a 3D image may be received by the tuner 201 through a broadcasting network. However, since this does not correspond to the characteristics of the present invention, detailed description of the same will be omitted for simplicity.

Meanwhile, the HDMI transmitter 111 of the source device 110 transmits 2D or 3D images to the HDMI receiver 209 of the sink device 200.

For example, the HDMI transmitter 111 of the source device 110 encodes the video signal for 3D image (i.e., 3D source data) according to the TMDS standard. Thereafter, the HDMI transmitter 111 of the source device 110 transmits the encoded video signal to the HDMI receiver 209 of the sink device 200 through an HDMI cable. At this point, the HDMI transmitter 111 of the source device 110 also transmits an audio signal to the HDMI receiver 209 of the sink device 200. However, since the audio signal being received by the HDMI receiver 209 does not correspond to the characteristics of the present invention, detailed description of the same will be omitted for simplicity.

According to an embodiment of the present invention, if the sink device 200 supports 3D images (or if the sink device 200 is 3D-supportable), a monitor name included in the EDID stored in the EEPROM 210 is set to “3D TV”. Then, the monitor name is transmitted to the controller 112 of the source device 110. More specifically, if the sink device 200 supports 3D images, the sink device 200 sets the monitor name of the EDID to “3D TV” and transmits this EDID to the source device 110 through the DDC. In this case, the monitor name becomes the identification information that enable the source device 110 to recognize the sink device 200 as being 3D-supportable.

By verifying a monitor name value of the received EDID, the controller 112 of the source device 110 can determine whether or not the sink device 200 being connected by the HDMI cable supports 3D images. More specifically, if the monitor name of the EDID transmitted from the sink device 200 is set to “3D TV”, the controller 112 of the source device 110 recognizes the sink device (i.e., the digital TV receiver) connected via DDC communication as a TV receiver that can support 3D TV.

The controller 112 of the source device 110 controls the source device 110 so that the video signal for 3D image can be transmitted to the HDMI receiver 209 of the sink device 200, only when the monitor name value indicates that the corresponding sink device is 3D-supportable. At this point, according to the embodiment of the present invention, also transmits a transmission format of the 3D image to the HDMI receiver 209 of the sink device 200.

Meanwhile, if the monitor name value indicates that the corresponding sink device does not support 3D images, the controller 112 of the source device 110 controls the source device 110 so that a video signal for 2D image can be transmitted to the HDMI receiver 209 of the sink device 200.

Furthermore, when the HDMI transmitter 111 of the source device 110 transmits the video signal for 3D image, any one of a resolution determined (or set-up) in the source device 110 and a resolution supported by the sink device 200 for 3D images may be selected as the resolution of the corresponding 3D image. In order to do so, according to the embodiment of the present invention, the sink device 200 determines (or sets up) a resolution supportable by the corresponding sink device in the EDID stored in the EEPROM.

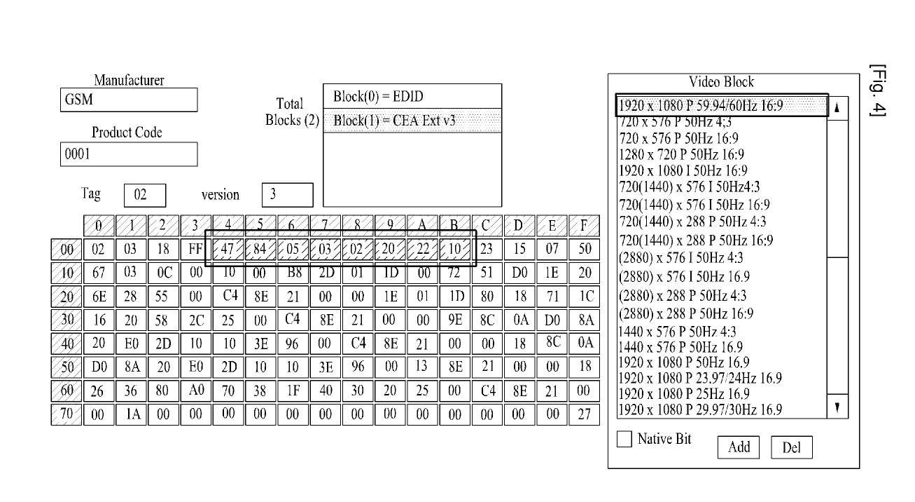

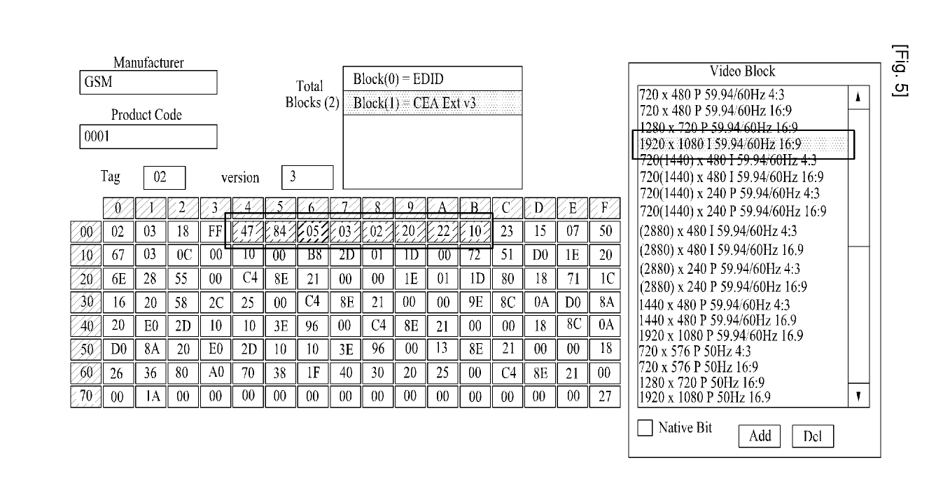

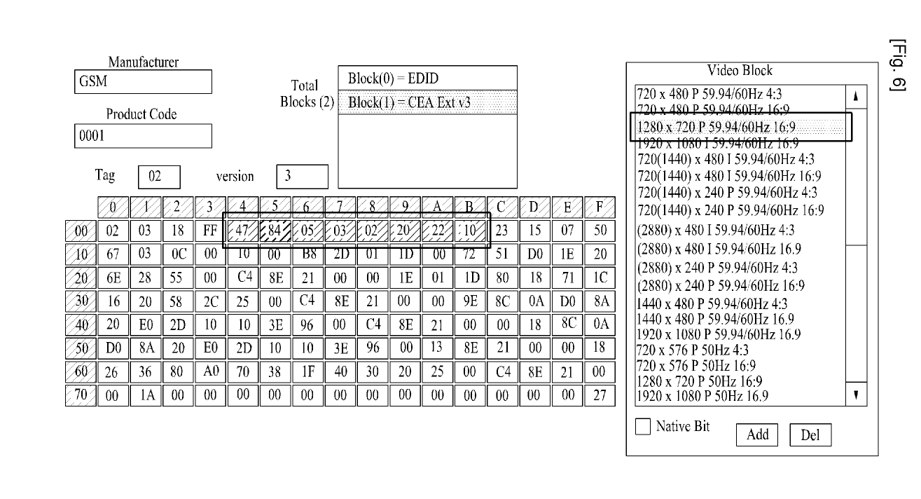

FIG. 4 to FIG. 6 respectively illustrate examples of setting-up (or determining) resolutions supportable by the sink device 200 according to the present invention in a video block of the EDID stored in the EEPROM. As shown in FIG. 4 to FIG. 6, a wide range of resolutions may be supported by the sink device 200. Particularly, in the description of the present invention, it is assumed that a 1920×1080P 59.94/60 Hz 16:9 mode (hereinafter referred to as “1080P” for simplicity) shown in FIG. 4, a 1920×1080I 59.94/60 Hz 16:9 mode (hereinafter referred to as “1080I” for simplicity) shown in FIG. 5, and a 1280×720P 59.94/60 Hz 16:9 mode (hereinafter referred to as “720P” for simplicity) shown in FIG. 6 are resolutions supported by the sink device 200 for 3D images. Herein, P represents “progressive”, and I signifies “interlaced”.

Resolutions supportable by the sink device 200 including 1080P, 1080I, and 720P are determined (or set up) in the video block of the EDID, as shown in FIG. 4 to FIG. 6, thereby being outputted to the controller 112 of the source device 110 through the DDC. The controller 112 of the source device 110 refers to the resolutions provided from the sink device 200 and also refers to the resolutions determined (or set up) in the corresponding source device 110, thereby deciding the resolution of the video signal of the 3D image that is to be transmitted to the sink device 200. Subsequently, the controller 112 of the source device 110 controls the HDMI transmitter 111 of the source device 110 so that the HMDI transmitter 111 can transmit the video signal of the 3D image at the decided resolution.

For example, among the resolutions supportable by the sink device 200, the source device 110 transmits the video signal for the 3D image at an optimal resolution to the sink device 200. In the present invention, it is assumed that 1080P is the optimal resolution among the resolutions supportable by the sink device 200. In this case, based upon the control of the controller 112, the HDMI transmitter 111 of the source device 110 transmits the video signal for the 3D image at the resolution of 1080P to the HDMI receiver 209 of the sink device 200. Since the 1080P, which is mentioned as the optimal resolution in the present invention, is a numeric value that may be modified or varied along with the development or evolution of the related technology, the scope and spirit of the present invention will not be limited only to the numeric value given in the description of the present invention.

In another example, if the resolution is predetermined (or presented) in the source device 110, the source device 110 transmits the video signal for the 3D image at the predetermined resolution to the HDMI receiver 209 of the sink device 200. For example, if the resolution predetermined in the source device 110 corresponds to 1080P, then the source device 110 transmits the video signal for the 3D image at resolution 1080P to the sink device 200. And, if the resolution predetermined in the source device 110 corresponds to 720P, then the source device 110 transmits the video signal for the 3D image at resolution 720P to the sink device 200.

If the source device 110 transmits the video signal for the 3D image at resolution 1080P to the sink device 200, this corresponds to a case where the video signal for the 3D image is transmitted at its optimal resolution. Therefore, the sink device 200 may process and display the received video signal for the 3D image in accordance with the respective transmission format.

However, when it is assumed that the source device 110 transmits the video signal for the 3D image at a resolution other than 1080P, e.g., at a resolution of 720P, according to an embodiment of the present invention, the sink device 200 displays a message indicating the optimal resolution to the user. For example, based upon the control of the controller 250, the UI screen processing unit 211 may process a guidance message via on-screen display (OSD) indicating, “The optimal resolution of this TV receiver is 1080P.” Thereafter, the UI screen processing unit 211 may display the message to the display unit 208.

At this point, when the user sets the resolution of the source device 110 to 1080P through a user command input unit 300, the source device 110 modifies (or changes) the video signal for the 3D image to a resolution of 1080P, thereby transmitting the modified video signal to the sink device 200. The user command input unit 300 may corresponds to a remote controller, a keyboard, a mouse, a menu screen, a touch screen, and so on. Thus, the user may be able to view the 3D image at its optimal resolution.

However, if the user fails to change the resolution settings despite the display of the guidance message, the source device 110 transmits the video signal for the 3D image at a resolution of 720P to the sink device 200.

Meanwhile, if the source device 110 transmits a video signal for the 3D image at a resolution higher than the 3D-supportable resolution of the sink device 200 (e.g., if the source device 110 transmits the video signal at a resolution of 1440P), the UI screen processing unit 211 may process a guidance message via on-screen display (OSD) indicating, “1440P is a resolution not supported by this TV receiver.” In this case also, by displaying a message indicating the optimal resolution of the sink device, the user may be guided to select the optimal resolution of the sink device.

Furthermore, if the 3D-supportable resolution of the sink device 200 does not exist (e.g., if 480P is the only resolution supported by the sink device 200), the UI screen processing unit 211 may generate and display an error message indicating, “This TV cannot display 3D images.”

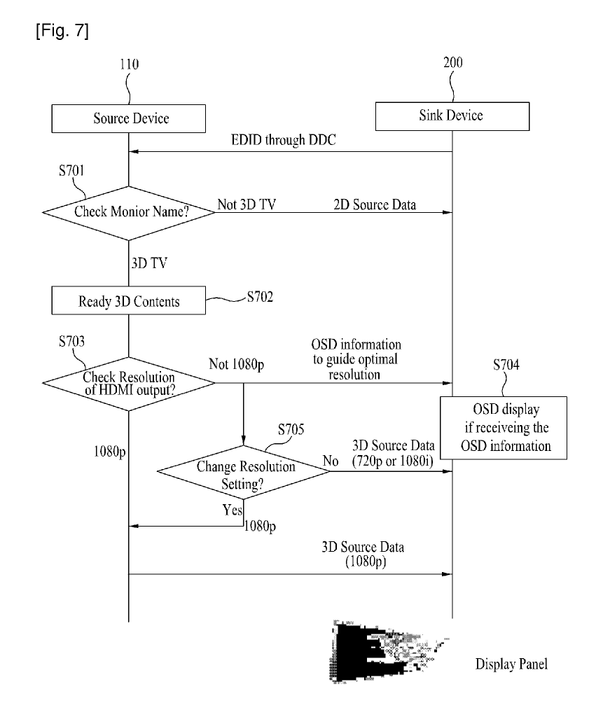

FIG. 7 illustrates a flow chart showing the process steps of a method of processing data for 3D images in the source device and the sink device according to an embodiment of the present invention. More specifically, when it is assumed that the sink device 200 is a digital TV receiver, FIG. 7 shows a method of processing data between the source device 110 and the sink device 200 according to an embodiment of the present invention.

First of all, if the corresponding sink device 200 supports 3D images, the sink device 200 sets the monitor name value of the EDID stored in the EEPROM 210 to a value enabling the sink device 200 to be recognized as 3D-supportable. Also, other resolutions supported by the sink device 200 are set in the video block of the EDID. According to the embodiment of the present invention, if the corresponding sink device 200 is 3D-supportable, the resolutions supported by the sink device 200 include at least one of the resolutions for 3D images (e.g., 1080P, 1080I, and 720P).

If the power of the sink device is turned on, or if a new source device is connected to the sink device through the HDMI cable, or if the sink device had been changed to a different input mode and then returned to its initial input mode, the sink device 200 transmits the EDID stored in the EEPROM 210 to the source device 110. More specifically, the sink device 200 transmits the EDID stored in the EEPROM 210 to the source device 110 through the DDC. The source device 110 analyzes the monitor name value of the EDID provided from the sink device 200, so as to verify whether or not the sink device 200 transmitting the EDID supports 3D images (S701). For example, if the monitor name of the EDID transmitted from the sink device 200 is not set to “3D TV”, the source device 110 decides (or determines) that the sink device 200 does not support 3D images. In this case, the source device 110 transmits a video signal for a 2D image (i.e., 2D source data) to the sink device 200.

Meanwhile, if the monitor name of the EDID transmitted from the sink device 200 is set to “3D TV”, the source device 110 decides (or determines) that the sink device 200 supports 3D images. In this case, the source device 110 prepares a set of 3D contents, i.e., a video signal for the 3D image (i.e., 3D source data), that is to be transmitted to the sink device 200 (S702). Thereafter, the resolution of the 3D image that is to be transmitted is decided (S703). For example, any one of the resolutions supported by the sink device 200 for the provided 3D images may be decided as the resolution of the 3D image, or a resolution predetermined (or set-up) in the source device 110 may be decided as the resolution of the corresponding 3D image. If the resolution decided in step 703 corresponds to the optimal resolution (i.e., 1080P), the source device 110 transmits the video signal for 3D image at the predetermined resolution to the sink device 200.

Alternatively, if the resolution decided in step 703 does not correspond to the optimal resolution (i.e., 1080P), the source device 110 transmits OSD information for guiding the optimal resolution to the sink device 200. When the sink device 200 receives the OSD information, the sink device 200 may process a guidance message via on-screen display (OSD) and display the guidance message (S704). For example, the sink device 200 may display a guidance message indicating, “The optimal resolution of this TV receiver is 1080P.” If the user changes source device setting to the optimal resolution (i.e., 1080P), based upon the guidance message in step 704, the source device 110 changes the resolution of the video signal for the 3D image to 1080P, thereby transmitting the changed video signal to the HDMI receiver 209 of the sink device 200 (S705).

The HDMI receiver 209 of the sink device 200 performs TMDS decoding on the received video signal for 3D image, thereby outputting the TMDS-decoded video signal to the video processor 206. If the inputted video signal is HDCP-scrambled, the video processor 206 performs HDCP-descrambling on the received video signal based upon the control of the controller 250. For example, the EEPROM 210 stores key information and authentication bits used for the HDCP-scrambling process. And, the controller 250 uses the key information and authentication bits stored in the EEPROM 210 so as to control the descrambling process of the video processor 206.

Additionally, the video signal being received by the HDMI receiver 209 may be configured in a YCbCr format or in an RGB format. In this case, based upon the control of the controller 250, the video processor 206 may perform color space conversion of the inputted video signal. More specifically, if the color space of the inputted video signal is not identical to the color space of the display unit 208, the video processor 206 performs color space conversion. For example, if the color space of the inputted video signal is RGB, and if the color space of the display unit 208 is YCbCr, the RGB format video signal is converted to the YCbCr format video signal. If the video signal processed by the video processor 206 corresponds to a video signal of a 2D image, the corresponding video signal bypasses the 3D formatter 207, thereby being outputted to the display unit 208.

Alternatively, if the video signal processed by the video processor 206 corresponds to a video signal of a 3D image, the corresponding video signal is outputted to the 3D formatter 207. The 3D formatter 207 formats the video signal being outputted from the video processor 206, based upon the transmission format of the 3D image, thereby outputting the formatted video signal to the display unit 208. For example, if the 3D image formatted by the 3D formatter 207 corresponds to a stereo image, the video signal of the right-view image and the video signal of the left-view image are outputted at the resolution provided by the source device 110. According to the embodiment of the present invention, the transmission format of the 3D image is provided from the source device 110. The display unit 208 creates a 3D image through a variety of methods using the left-view image and right-view image of the formatted video signal, thereby displaying the created 3D image. As described above, the display method includes a method of wearing special glasses and a method of not wearing any special glasses.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### MODE FOR THE INVENTION

Meanwhile, the mode for the embodiment of the present invention is described together with the ‘best Mode’ description.

### INDUSTRIAL APPLICABILITY

The embodiments of the method for transmitting and receiving signals and the apparatus for transmitting and receiving signals according to the present invention can be used in the fields of broadcasting and communication.

1. In a method of processing 3-dimensional (3D) images of an audio/video system, wherein the audio/video (A/V) system includes a sink device and a source device connected through a digital interface, the method of processing 3D images of the audio/video system comprises:
transmitting identification information indicating whether or not the sink device supports 3D images from the sink device to the source device; and
transmitting a 3D image signal from the source device to the sink device when the sink device is verified to be 3D-supportable based upon the identification information.

2. The method of claim 1, wherein transmitting identification information sets a monitor name of extended display identification data (EDID) to a value indicating the 3D image support and transmits the monitor name value to the source device when the sink device is 3D-supportable.

3. The method of claim 2, wherein the EDID is transmitted to the source device through a display data channel (DDC).

4. The method of claim 2, further comprising:
transmitting resolution information including at least one resolution supportable for 3D images from the sink device to the source device.

5. The method of claim 4, wherein the resolution information including at least one resolution supportable for 3D images is set up in a video block of the EDID by the sink device, thereby being transmitted to the source device.

6. The method of claim 4, wherein, in the transmitting a 3D image signal, the 3D image signal is transmitted at a resolution of a highest picture quality among the resolutions included in the resolution information transmitted from the sink device.

7. The method of claim 4, comprising:
if the resolution set up in the source device is lower than a resolution of a highest picture quality, the resolution being supportable for 3D images, displaying a guidance message enabling a user to recognize the resolution of the highest picture quality supportable by the sink device.

8. The method of claim 7, comprising:
when resolution settings of the source device are changed by the user to the resolution of the highest picture quality, transmitting the 3D image signal at the changed resolution.

9. The method of claim 1, further comprising:
transmitting 3D information including a transmission format of the 3D image to the sink device.

10. The method of claim 1, wherein the transmitting a 3D image signal further comprises:
when it is verified that the sink device does not support 3D images based upon the identification information, having the source device transmit a 2D video signal to the sink device.

11. An audio/video system, comprising:
a source device providing one of a 2D image signal and a 3D image signal through a digital interface; and
a sink device processing and displaying one of the 2D image signal and the 3D image signal provided through the digital interface,
wherein the sink device transmits identification information indicating whether or not the sink device supports 3D images to the source device, and
wherein the source device transmits the 3D image signal to the sink device when the sink device is verified to be 3D-supportable based upon the identification information.

12. The audio/video system of claim 11, wherein, if the sink device is 3D-supportable, the sink device sets up a monitor name of extended display identification data (EDID) to a value indicating the 3D image support, thereby transmitting the monitor name value to the source device.

13. The audio/video system of claim 12, wherein the EDID is transmitted to the source device through a display data channel (DDC).

14. The audio/video system of claim 12, wherein the sink device transmits resolution information including at least one resolution supportable for 3D images to the source device.

15. The audio/video system of claim 14, wherein the sink device sets up resolution information including at least one resolution supportable for 3D images in a video block of the EDID, thereby transmitting the resolution information to the source device.

16. The audio/video system of claim 14, wherein the source device transmits the 3D image signal at a resolution of a highest picture quality among the resolutions included in the resolution information transmitted from the sink device.

17. The audio/video system of claim 14, wherein, if the resolution set up in the source device is lower than a resolution of a highest picture quality, the resolution being supportable for 3D images, the sink device displays a guidance message enabling a user to recognize the resolution of the highest picture quality supportable by the sink device.

18. The audio/video system of claim 17, wherein, when resolution settings of the source device are changed by the user to the resolution of the highest picture quality, the source device transmits the 3D image signal at the changed resolution.

19. The audio/video system of claim 11, wherein the source device transmits 3D information including a transmission format of the 3D image to the sink device.

20. The audio/video system of claim 11, wherein, when it is verified that the sink device does not support 3D images based upon the identification information, the source device transmits a 2D video signal to the sink device.
